(19) United States
(12) Patent Application Publication
(10) Pub. No.: US 2005/0255360 A1
(43) Pub. Date: Nov. 17, 2005

(54) Electrorheological design and manufacturing method for proton transport membranes and bipolar plates

(75) Inventors: Alvin Post, Gilbert, AZ (US); Bradley Rogers, Chandler, AZ (US); Govindasami Tamizhmani, Gilbert, AZ (US)

Correspondence Address: David S. Harper;McDonnell Boehnen Hulbert & Berghof LLP, Suite 3100, 300 South Wacker Drive, Chicago, IL, 60606, US

(73) Assignee: Arizona State University

(21) Appl. No.: 10/997,286

(22) Filed: Nov. 24, 2004

Related U.S. Application Data
(60) Provisional application No. 60/525,146, filed on Nov. 25, 2003.
(60) Provisional application No. 60/525,643, filed on Nov. 26, 2003.

(51) Int. Cl. H01M 8/02; H01M 8/10

(52) U.S. Cl. 429/34; 429/30; 429/33

(57) ABSTRACT

Proton transport membranes and bipolar plates for use in fuel cell stacks are generally discussed herein with particular discussions extended to proton transport membranes and bipolar plates made from electrorheological (ER) fluids. By combining electrically polarizable aggregates, such as carbon particles, with a phase changing medium to form an electroset composition and exposing the same to an electric field, the composition behave as an ER fluid and the polarizable aggregates form long chains in the direction of the field gradient. The composition is permanently cured in this condition and resultant product may be used as membranes, if catalysts are added, or bipolar plates in a fuel cell stack.

Proton transport membranes and bipolar plates for use in fuel cell stacks are generally discussed herein with particular discussions extended to proton transport membranes and bipolar plates made from electrorheological fluids.

### CROSS-REFERENCE TO RELATED APPLICATIONS

This is an ordinary application of Ser. No. 60/525,146 filed Nov. 25, 2003 and of Ser. No. 60/525,643 filed Nov. 26, 2003, their contents are expressly incorporated herein by reference as if set forth in full.

### BACKGROUND

That hydrogen combines with oxygen to produce water and electric current was first discovered by Sir William Robert Grove in 1839. As early as in the 1950's, scientists from NASA utilized this discovery to develop power sources that would power space exploration vehicles. These power sources are known as fuel cells or fuel cells stacks, which are large numbers of individual fuel cells stacked together in series. Fuel cells hold great promise as a low emission alternative power source. Rather than combustion, hydrogen and oxygen combine in a chemical reaction to produce electricity and water. This process has been referred to an a reverse electrolysis process.

Fuel cells are generally classified by fuel cell types, categorized primarily by the kind of electrolyte they employ. The type of electrolyte will determine the chemical reaction that takes place, the fuel supply required, the operating temperature range, the catalysts needed, and other factors, such as controls, fuel storage, and fuel generation. Different fuel cell classes have been studied and they include: Polymer Electrolyte Membrane (PEM), Direct Methanol, Solid Oxide, Alkaline, Phosphoric Acid, Regenerative, and Molten Carbonate.

For the PEM fuel cells, the voltage produced from a single fuel cell is relatively low, in the order of about 0.7 volts potential difference. Therefore, for fuel cells to be useful, they must operate in stacks and connected to one another in series. However, rather than wiring the individual fuel cells in series, bipolar plates are used. A single bipolar plate is a conductive layer of material placed between adjacent layers in a fuel cell stack. It collects electrons from the active layer of a fuel cell for delivery outside the cell, or for delivery to the next layer. It also contains conduits, or flow channels, through which fuel is distributed, and it conducts waste heat away from the active layer. Gaskets are typically installed between the plate and the active layers to prevent fuel leakage.

A prior art bipolar plate is typically made from a carbon-based material. Carbon plates are rigid and are machine capable to form a desired shape and configuration. The bipolar plate must also be sufficiently thick to avoid breakage. However, thickness and fabrication requirements tend to increase production costs and overall fuel stack size and therefore make fuel cells less desirable.

Another feature of a PEM fuel cell is the proton exchange membrane, which is typically a polymer layer that separates the oxygen from the hydrogen. It has the unusual property in that it conducts protons, but not electrons. In a fuel cell, hydrogen breaks down on one side of the membrane and protons flow through the membrane toward the oxygen while electrons move away from the membrane. To cause the hydrogen to break down, catalysts are added in a porous carbon “sponge”, which is also known in the industry as a gas diffusion layer.

For a chemical reaction to occur to produce electricity, hydrogen, carbon (or another electron conductor), platinum, and the membrane must be in contact at almost exactly the same points, on a micro-scale, on one side of the membrane. The situation is the same on the other side of the membrane, except that oxygen must be present instead of hydrogen. Presently, the diffusion layer is typically coated with fine platinum particles, pressed against the membrane, and flooded with hydrogen. By chance, there will be a number of sites at the surface of the membrane where all four necessary components are in contact. This allows the fuel cell to work. However, this process is inefficient and wasteful, because most of the platinum (about 85%) resides inside the diffusion layer and is not close enough to the membrane to catalyze the hydrogen reaction. In addition, only the surface of the membrane is available to provide reaction sites.

Accordingly, there is a need for a more efficient use of catalysts for reaction in a fuel cell stack and a bipolar plate that is less costly to produce.

### SUMMARY

The present invention may be implemented by providing a fuel cell stack comprising a bipolar plate, a gas diffusion layer, and a proton exchange membrane, wherein the bipolar plate comprises a plurality of spaced apart chains of polarizable particles made polarized and aligned into chains by an electric field.

In another aspect of the present invention, there is provided a fuel cell stack comprising a bipolar plate, a gas diffusion layer, and a proton exchange membrane, wherein the proton exchange membrane comprises a plurality of spaced apart chains of catalyst coated polarizable particles made polarized and aligned into chains by an electric field.

Yet in another aspect of the present invention, there is provided a method for manufacturing a fuel cell stack comprising the steps of providing a bipolar plate, providing a gas diffusion layer, providing a proton exchange membrane, and causing a plurality of polarizable particles located inside the bipolar plate or the proton exchange membrane to align in spaced apart chains through application of an electric field.

### BRIEF DESCRIPTION OF THE DRAWINGS

These and other features and advantages of the present invention will become appreciated as the same becomes better understood with reference to the specification, claims and appended drawings wherein:

FIG. 1 is an exemplary depiction of a fuel cell stack provided in accordance with aspects of the present invention;

FIG. 2 is a semi-schematic of a catalyst coated polarizable particle provided in accordance with aspects of the present invention;

FIG. 3 is an exemplary depiction of an electroset composition disposed between a pair of electrodes;

FIG. 4 is an exemplary depiction of a plurality of chains of polarized particles inside an electroset composition after alignment caused by the electric field;

FIG. 5 is a semi-schematic cross-sectional view of a proton exchange membrane and a pure proton conduction layer; and

FIG. 6 is an exemplary manufacturing scheme for producing bipolar plate sheets and the surface layers of membrane sheets.

### DETAILED DESCRIPTION

The detailed description set forth below in connection with the appended drawings is intended as a description of the presently preferred embodiments and methods for making bipolar plates and proton exchange membranes (herein PEMs or membranes) provided in accordance with aspects of the present invention and is not intended to represent the only forms in which the present invention may be constructed or utilized. The description sets forth the features and the steps for constructing and using the bipolar plates and membranes of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like or similar elements or features.

Referring now to FIG. 1, a semi-schematic depiction of a fuel cell stack 10 provided in accordance with aspects of the present invention is shown. The fuel cell stack 10 comprises a plurality of individual fuel cells stacked on top of one another, with only two complete fuel cells 12 shown in FIG. 1. The fuel cell stack 10 comprises the following components in repeat pattern: a bipolar plate 14, a gas diffusion layer 20, which in a preferred embodiment is a carbon sponge-like layer, a proton exchange membrane 22, which includes a cathode layer 16 and an anode layer 18, another gas diffusion layer 20, and another bipolar plate 14 and so forth.

In general terms, fuel cells operate by passing oxygen molecules over the cathode layers 16 and hydrogen molecules over the anode layers 18. As hydrogen molecules contact the anode layers 18, they dissociate into protons and electrons. Electrons flow out of the cells to be used as electrical energy while the protons pass across the membrane layers 22 to the cathode layers 16. At the cathode layers 16, oxygen molecules split into atomic oxygen and then combine with the protons that have crossed the membrane layers 22. Electrons previously released from the anode side also flow into this region through an external circuit and are consumed in the chemical reaction, thus completing an electrical circuit. Water is formed and heat is produced as a result of the chemical reaction between the protons and the oxygen atoms. To facilitate the breakdown of hydrogen molecules and oxygen into oxygen atoms, catalysts, typically platinum, are placed or impregnated inside the gas diffusion layer 20

In one aspect of the present invention, carbon particles coated with tightly adhering catalyst particles are used in an electrorheological (herein ER) fluid or electroviscous fluid and the fluid is caused to undergo a phase change or solidify in the presence of an electric field. The solidified mixture, also referred to as an electroset composition, may then be used as a surface layer of the membrane 22. As further discussed below, this process allows coated carbon particles, or other suitable particles or fibers, to align inside a thin sheet of liquefied proton conduction membrane and then cured to serve as flow paths for the electrons. Electrons flow through the carbon chains to or from the surface of the membrane. Protons flow through the pure membrane, but not through the carbon chains.

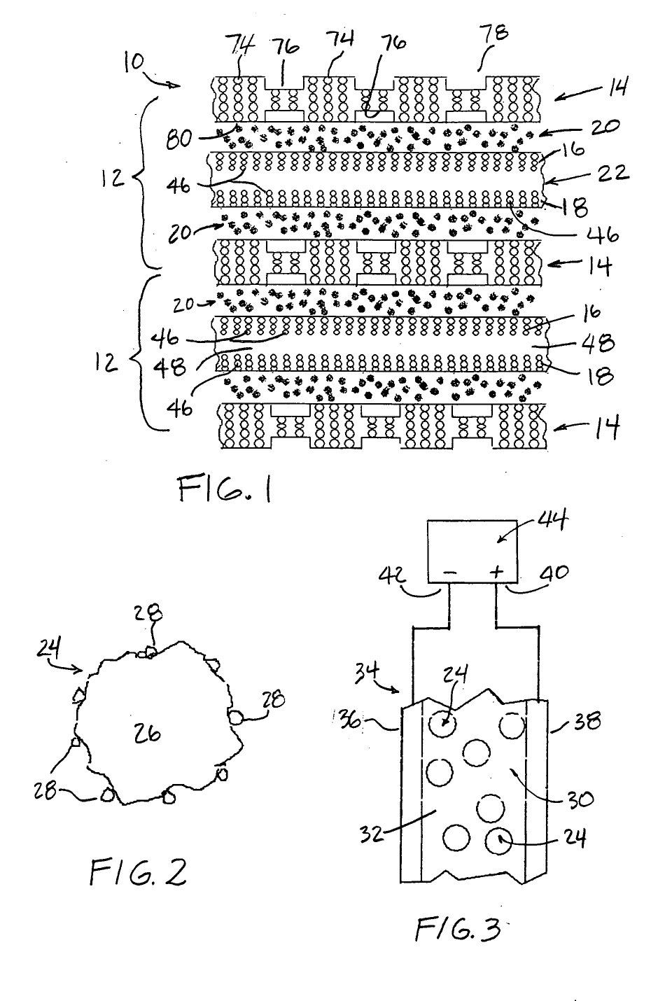

Referring to FIG. 2, an exemplary catalyst coated carbon particle 24 is shown. The carbon particle 26 may be coated with catalysts 28 and such particles are commercially available. Additional information regarding catalyst coated carbon particles 24 may be found in the publication entitled ‘Improved Electrocatalytic Oxygen Reduction Performance of Platinum Ternary Alloy-Oxide in Solid Polymer Electrolyte Fuel Cells’, by Tamizhmani and G. A. Capuano, Journal of the Electrochemical Society, 141, 968 (1994), which is expressly incorporated herein by reference in its entirety.

To form the membrane 22, the catalyst coated carbon particles 24 are added to an ion conducting phase changing medium, such as a perfluorosulfonic acid based polymer. The trade name for a common version perfluorosulfonic acid based polymer is NAFION™. The mixture is subjected to an electric field. The phase changing medium preferably has a different dielectric constant than the particles. The electric field causes the individual carbon particles 24 to be polarized and align in chains in the medium. The medium is allowed to cure under the presence of the electric field or alternatively allowed to air cure or heat cure after removal of the electric field. With the exception of the electric field, the described process is similar to a process known as liquid resin casting. In an alternative embodiment, the membrane 22 may be made by blending catalyst coated carbon particles 24 with melted ion conducting membrane material and using extrusion, injection molding or other known molding techniques along with an electric field to produce the desired shape and dimension.

The carbon chains described above conduct electrons. The carbon chains serve to allow electrons to travel between the gas diffusion layer and reaction sites that lie beneath the surfaces of the proton exchange membrane 22. A proton exchange membrane 22 will function ineffectively if electrons can pass completely through it along these carbon chains. It is also known that electrons will not pass through a proton exchange membrane such as a perfluorosulfonic acid based polymer in the absence of separate conductive paths, such as the carbon chains. Therefore, in one embodiment, a pure proton conduction layer is constructed as a middle layer 48 of the membrane 22. Thus, in one exemplary embodiment, the membrane layer 22 will have a pure proton conduction layer 48 in between layers of PEM comprising catalyst coated carbon chains formed in the manner described above. The resulting 3-layer membrane, in a fuel cell, will allow protons to pass through but will prevent the passage of electrons.

The process of shaping an ER fluid, the process of placing aggregates in a dielectric fluid to cause the combination of fluid and aggregates to behave electroviscously, the process of fabricating composite articles using electroset materials (i.e., materials that comprise a phase changing vehicle and electrically polarizable aggregates), and examples of ER fluids and aggregates are disclosed in U.S. Pat. Nos. 4,687,589; 3,427,247; 3,970,573; 3,954,339; 4,502,973; 4,737,886; 5,980,813; 5,190,624; 5,194,181; 5,213,713; 5,904,977 (the last four patents issued to Reitz). Therefore other than recognizing that the methods described herein involve manipulating electroset compositions, further detailed discussions regarding ER fluids and related subjects are deemed unnecessary. The contents of these patents are expressly incorporated herein by reference as if set forth in full.

Referring now to FIG. 3, a exemplary schematic diagram depicting an electroset composition 30 comprising a phase changing medium 32 and catalyst coated carbon particles 24 in a mold 34 comprising a pair of electrodes 36, 38 is shown. The electroset composition 30 may be prepared by placing a quantity of phase changing medium 32 into a mixer assembly (not shown), adding a desired quantity of catalyst coated carbon particles 24, and then mixing the two thoroughly to form an admixture. In one exemplary embodiment, the ratio of catalyst coated carbon particles by weight of phase changing medium is high. In another embodiment, a ratio of about 13 parts carbon to about 5 parts (cured) polymer by weight may be used. Note that uncured polymer has a high percentage of volatile compounds. Thus, before the polymer is cured, the ratio may be different. In a preferred embodiment 9-17 parts carbon to about 3-7 parts (cured) polymer by weight may be used. In an alternative embodiment, platinum particles may be added directly to the phase changing medium 32 without using carbon particles 26. However, this option may require more platinum catalysts than necessary.

The blended electroset composition 30 may be transferred to the mold 34 by pouring the same into the mold. In one embodiment, transfer or dispensing equipment (not shown) may be used to transfer the composition 30 from the mixer assembly into the mold. The dispensing equipment may include one or more transfer pumps, control valves, flow gauges, and other known devices for transferring a product from a first location to a second location.

In one exemplary embodiment, the mold 34 comprises a housing structure in which two electrodes 36, 38 form at least part of two of the walls of the housing. The housing may comprise a rectangular shape configuration having a depth D, width W, and height H, which corresponds to a desired membrane 22 dimension and shape. In an alternative embodiment, the mold may be made from both electrically conductive material and dielectric material, which may include a number of plastics such as polyethylene, vinyl, polyester, silicone rubber, etc., and may include teflon or KAPTON™. The electrodes may be connected to the conductive sections of the mold. Still alternatively, the mold may be made by co-molding the electrodes with dielectric materials. In a preferred embodiment, a dielectric coating or layer is incorporated over the electrodes to minimize arcing and a potential for large current flow through the composition. The electrodes, which may be aluminum strips, may then be connected to a positive terminal 40 and a negative terminal 42 of a high voltage supply source 44 for generating an electric field.

In one exemplary embodiment, voltages of between 2000 and 4000 volts per mm of thickness (distance between electrodes) may be used. However, other voltage range may be incorporated depending on the application time, electrode size, mold configuration, polymers selected, whether the electrodes are coated, the gap size, etc. In one exemplary embodiment, the voltage will be applied for anywhere from a few seconds to many minutes up to about 1 hour. Again, the time range can vary depending on how long it takes for the resin or polymer to start to gel. Once the resin starts to gel, the particles are essentially locked in place and the voltage can be dropped or terminated altogether. In an alternative embodiment, the voltage may be gradually decreased over time before gelling begins. The current should be relatively low, in the order of about a milliamp per square cm. In a preferred embodiment, about 0.5 milliamp to about 3 milliamps per square cm of current may be applied.

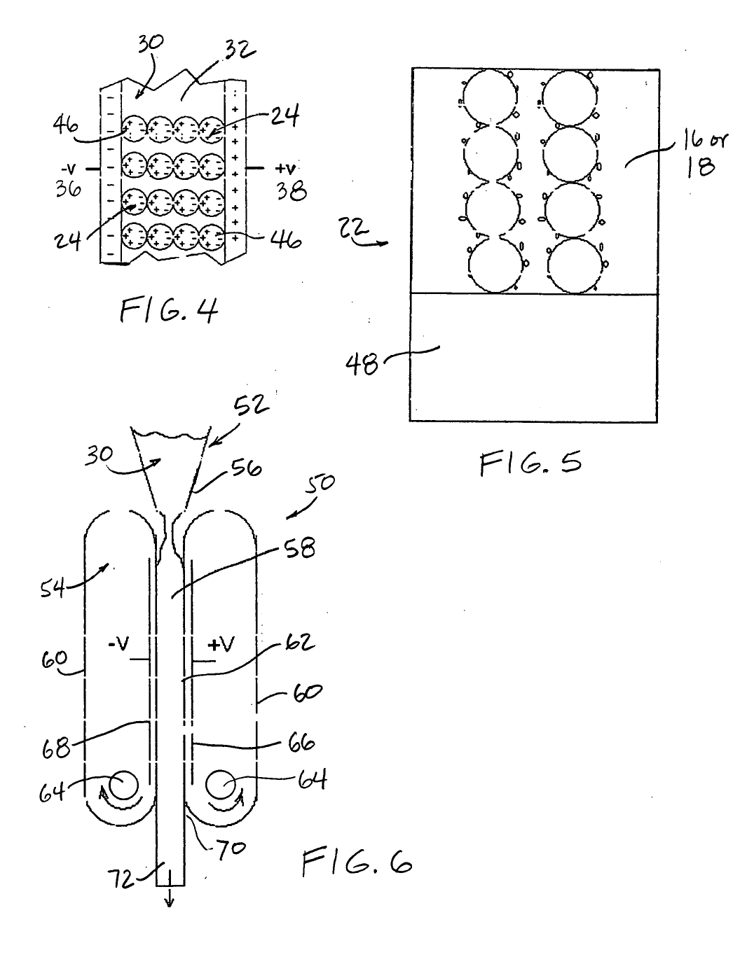

In the presence of the electric field, particles are electrically polarized and align in the phase changing medium under the influence of the electric field (FIG. 4). The particles 24 form chains 46 from one side of the medium 32 to the other, in the direction of the field gradient. The electric field is maintained until the medium 32 cures, thereby locking the chains 46 in the formation shown.

The cured electroset composition 30 may then be removed from the mold 34 and incorporated as a proton exchange membrane 22 in the fuel cell stack 10 shown in FIG. 1. In one exemplary embodiment, a mold release is first applied to the mold just prior to adding the electroset composition. The mold release allows the cured composition 30 to be easily removed from the mold and the electrodes 36, 38.

In one exemplary embodiment, pre-processing of the electroset composition 30 or post-processing of the cured composition 30 may be performed to ensure that the chains 46 of particles formed are exposed through the surface of the membrane 22 for reaction. Pre or post treatment examples may include: (a) etching away part of the perfluorosulfonic acid based polymer with, for example, alcohol, (b) burning away the perfluorosulfonic acid based polymer layer in a pyrolysis process, and (c) coating the surface of the mold with a non-curable layer of gel or liquid that will form the surface of the membrane, but which can later be washed off. Alternatively, the composition 30 may be “skinned” by electrically manipulating the composition during fabrication.

The membrane 22 provided in accordance with aspects of the present invention is configured to provide a plurality of electrically conductive paths, via the chains 46, for the electron flow paths. Referring again to FIG. 1 and as previously discussed, protons formed when hydrogen molecules come into contact with the anode layer 18 and will then travel through the membrane 22 to react with oxygen atoms to form water. However, unless deterred or prevented, electrons may similarly flow through the membrane 22. Thus, as previously discussed, in a preferred embodiment, a layer of pure proton conduction material 48 is laminated in the center of the membrane 22 (FIG. 5) to prevent the flow of electrons through the membrane (only one of the layers with polarized chains of particles is shown in FIG. 5). In one exemplary embodiment, this pure proton conduction layer 48 is made from perfluorosulfonic acid based polymer and is laminated to the membrane 22 through an over-molding process. The 3-ply membrane layer may also be formed using liquid resin casting methods and conventional molding methods.

FIG. 6 is an exemplary scheme for manufacturing a layer of electrorheologically organized material in a continuous process. In one exemplary embodiment, the process comprises a fabricating assembly 50 comprising a feed system 52 and a forming system 54. The feed system 52 comprises means for mixing an admixture of electroset composition 30, means for delivering the admixture to a feeding chamber 56, and means for outputting the admixture to the forming system 54. In one exemplary embodiment, conventional devices, such as pumps, control valves, nozzles, pneumatic actuators, mixers, closed loop controls, etc., may be used to form the feeding chamber 56. In addition, means for introducing a pure proton conduction layer 48 to the center of the feeding chamber 56 or the forming system 54 for forming a 3-layer membrane is also incorporated.

In one exemplary embodiment, the forming system 54 comprises a forming chamber 58 for receiving the electroset composition 30 and a pair of rotating belts or conveyor belts 60 for moving the admixture through a curing chamber 62. Alternatively, rotating drums may be used instead of or in addition to conveyor belts. In one embodiment, at least one of the conveyor belts 62, preferably both conveyor belts, are directly or indirectly driven by a drive motor 64. The drive motor 64 may be coupled to a drive gear, reduction gears, and/or drive chains for rotating the belts. In one exemplary embodiment, the belts 60 are preferably formed from a non-conductive material, such as plastic, or nylon, and are lined with electrodes 66, 68. The electrodes are preferably placed subjacent the walls of the forming chamber 58. The length of the forming chamber 58 and the length of the electrodes 66, 68 should be sufficiently long to ensure adequate curing of the sheet at the exit end 70 of the fabricating assembly 50. If air cure or heat cure is required, the film or sheet of membrane 72 may be fed on a conveyor system (not shown) to a cutting station (not shown) for cutting the sheet to a desired length and then to a curing station (not shown) to either air cure or heat cure. Still alternatively, the sheet of membrane 72, if cured to a desired state, may be fed on a conveyor system directly to a packaging station (not shown) where it is then rolled and packaged. A person of ordinary skill in the art will recognize that changes to the assembly sequence and other process steps, such as post-treatment, testing, etc., may be made without deviating from the spirit and scope of the present invention.

In an alternative embodiment, the sheet or film 72 may be formed using conventional rubber and plastics equipment. For example, sheets of membrane 72 may be extruded in an extruder or molded in an injection molding machine. As is readily apparent to a person of ordinary skill in the art, the molds in the extruder or the molding machine will require modifications to incorporate electrodes for generating an electric field. The electric field would be used to align the polarizable particles (e.g., catalyst coated carbon particles 24) within the phase changing medium, as previously discussed.

Referring again to FIGS. 1, 3, and 4, in one exemplary embodiment, the bipolar plate 14 may be fabricated using similar processes as discussed above for the formation of the membrane 22. However, in making the bipolar plate 14, carbon particles or other electrically conductive particles 26 rather than catalyst coated carbon particles 24 are mixed with a phase changing medium 32. In one exemplary embodiment, about 40-65% particulates by volume is used to form the bipolar plate. In one exemplary embodiment, the phase changing medium is a polyurethane or epoxy. Like the membrane 22 produced from the steps described above, the bipolar plate 14 also contains long carbon particle chains 74 (FIG. 1) formed from one side of the plate to the other, in the direction of the field gradient. The chains 74 provide electrically conductive paths for conducting electrons between the gas diffusion layers of adjacent cells.

As is readily apparent to a person of ordinary skill in the art, the bipolar plate 14 formed in accordance with aspects of the present invention produces a final flexible structure that is capable of flexing and assembling to a fuel cell stack without separately using gaskets. Moreover, the plates 14 can be produced in sheets using the manufacturing scheme discussed above with reference to FIG. 6 or made with different configurations using conventional rubber and plastics equipment. Accordingly, in one aspects of the present invention, flow channels or grooves 76 may be incorporated on a first surface 78 and a second surface 80 of the bipolar plate 14 (FIG. 1). The grooves or channels 76 may function to transport gases for reaction and for moving the reacted molecules, such as water droplets and vapor, out of the bipolar plate 14. The number of grooves 76 and the groove layout can easily be configured or arranged using conventional molding techniques in connection with conventional rubber and plastics equipment or by liquid resin casting

Although limited preferred embodiments and methods for making bipolar plates and proton exchange membranes and their components have been specifically described and illustrated herein, many modifications and variations will be apparent to those skilled in the art. For example, graphite particles may be substituted for carbon particles, certain phase changing medium may be used in place of those expressly set forth above and in the patents incorporated herein by reference. Furthermore, it is understood and contemplated that features specifically discussed for one embodiment may be adopted for inclusion with another embodiment, provided the functions are compatible. For example, the continuous manufacturing process described with reference to FIG. 6 may also be used to produce sheets of bipolar plates. Accordingly, it is to be understood that the membranes and bipolar plates constructed according to principles of this invention may be embodied other than as specifically described herein. The invention is also defined in the following claims.

1. A fuel cell stack comprising a bipolar plate, a gas diffusion layer, and a proton exchange membrane, wherein the bipolar plate comprises a plurality of spaced apart chains of polarizable particles made polarized and aligned into chains by an electric field.

2. The fuel cell stack of claim 1, wherein the proton exchange membrane comprises a plurality of spaced apart chains of catalyst coated polarizable particles made polarized and aligned into chains by an electric field.

3. The fuel cell stack of claim 1, wherein the proton exchange membrane comprises a layer of pure proton conducting layer.

4. The fuel cell stack of claim 3, wherein the pure proton conducting layer is position between layers comprising polarized particles.

5. The fuel cell stack of claim 4, wherein the polarized particles comprise catalyst coated carbon particles.

6. The fuel cell stack of claim 4, wherein the pure proton conducting layer comprises perfluorosulfonic acid based polymer.

7. The fuel cell stack of claim 1, wherein the bipolar plate comprises cured polyurethane or epoxy.

8. The fuel cell stack of claim 1, wherein the bipolar plate comprises a plurality of grooves.

9. A fuel cell stack comprising a bipolar plate, a gas diffusion layer, and a proton exchange membrane, wherein the proton exchange membrane comprises a plurality of spaced apart chains of catalyst coated polarizable particles made polarized and aligned into chains by an electric field.

10. The fuel cell stack of claim 9, wherein the bipolar plate comprises a plurality of spaced apart chains of catalyst coated polarizable particles made polarized and aligned into chains by an electric field.

11. The fuel cell stack of claim 9, wherein the proton exchange membrane comprises a layer of pure proton conducting layer.

12. The fuel cell stack of claim 11, wherein the pure proton conducting layer is position between layers comprising polarized particles.

13. The fuel cell stack of claim 12, wherein the polarized particles comprise catalyst coated carbon particles.

14. The fuel cell stack of claim 12, wherein the pure proton conducting layer comprises perfluorosulfonic acid based polymer.

15. The fuel cell stack of claim 9, wherein the bipolar plate comprises cured polyurethane or epoxy.

16. The fuel cell stack of claim 9, wherein the bipolar plate comprises a plurality of grooves.

17. A method for manufacturing a fuel cell stack comprising:
providing a bipolar plate,
providing a gas diffusion layer,
providing a proton exchange membrane, and
causing a plurality of polarizable particles located inside the bipolar plate or the proton exchange membrane to align in spaced apart chains through application of an electric field.
